(19) United States
(12) Patent Application Publication
(10) Pub. No.: US 2024/0378071 A1
(43) Pub. Date: Nov. 14, 2024

(54) ENHANCED DATASTORES FOR VIRTUALIZED ENVIRONMENTS

(71) Applicant: VMware LLC, Palo Alto, CA (US)

(72) Inventors: Yogender SOLANKI, Bangalore (IN); Vikas SURYAWANSHI, Bangalore (IN)

(21) Appl. No.: 18/314,881

(22) Filed: May 10, 2023

(51) Int. Cl. G06F 9/455

(52) U.S. Cl. CPC G06F 9/45558; G06F 2009/45583

(57) ABSTRACT

Enhanced datastores for virtualized environments are disclosed. A virtual datastore (e.g., a virtual volume datastore) is generated, along with a first virtual storage object (e.g., a virtual volume object) having a first storage policy. The first virtual storage object is configured into a first logical container datastore (e.g., a virtual machine file system datastore). The virtual datastore and the first logical container datastore are connected to a hypervisor in a tiered configuration, with the virtual datastore between the hypervisor and the first logical container datastore. Data is stored in the first logical container datastore. In some examples, the virtual datastore is a hybrid datastore having both a subordinate logical container datastore and a subordinate virtual storage object datastore, with the logical container datastore being provisioned by the hypervisor and the virtual storage object being provisioned by the storage solution.

### BACKGROUND

A virtual machine (VM) file system (VMFS) is a high-performance cluster file system that provides storage in a virtualized environment and is typically optimized for VMs. VMFS is a native file system under some hypervisor VM kernels, and encapsulates VMs in files (e.g., VM disks, or VMDKs). In some deployments, VMFSs are used as datastores. However, when the number of VMs accessing the same datastore grows too high, resource contentions reduce operational efficiency. Additionally, when a VMFS is backed by a single logical unit number (LUN), the use of multiple simultaneous storage policies are unavailable, reducing opportunities to leverage relative advantages of different portions of a diverse storage solution.

When environments with large deployments have numerous hosts, input/output (I/O) failures become more significant considerations. A large VMFS volume shared across multiple hosts in a large cluster (e.g., 100 or so hosts) experiences I/O failures, slow block allocation, latency in file deletion, and slow un-map operations because many operations require synchronization between hosts when changing file system metadata, and all hosts share the volume resources. Larger clusters experience a higher number of atomic test and set (ATS) commands, which are used to atomically update the contents of a sector on a disk and for synchronization, because each host sends an ATS command for on-disk resource allocation. These scalability issues and failures lead to data corruption and I/O failure, which may deter the use of VMFS in large clusters.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the disclosure provide solutions for providing enhanced datastores for virtualized environments. Examples include: generating a virtual datastore (e.g., a virtual volume datastore); generating a first virtual storage object (e.g., a virtual volume object) having a first storage policy; configuring the first virtual storage object into a first logical container datastore (e.g., a virtual machine file system datastore); connecting the virtual datastore and the first logical container datastore to a hypervisor in a tiered configuration, with the virtual datastore between the hypervisor and first logical container datastore; and storing data in the first logical container datastore according to the first storage policy. In some examples, the virtual datastore is a hybrid datastore having both a subordinate logical container datastore and a subordinate virtual storage object datastore, with the logical container datastore being provisioned by the hypervisor and the virtual storage object being provisioned by the storage solution.

### BRIEF DESCRIPTION OF THE DRAWINGS

The present description will be better understood from the following detailed description read in the light of the accompanying drawings, wherein:

FIG. 1 illustrates an example architecture that advantageously provides enhanced datastores for virtualized environments;

FIG. 2 illustrates further detail for an example of an architecture that may be used;

FIG. 3 illustrates an example of a virtual storage object arrangement, as may be used in an example architecture such as that of FIG. 1;

FIG. 4 illustrates an example of a virtual machine (VM) file system arrangement, as may be used in an example architecture such as that of FIG. 1;

FIGS. 5-8 illustrate flowcharts of exemplary operations that may be performed in support of, and along with, example operations such as those of FIG. 3;

FIG. 9 illustrates another flowchart of exemplary operations associated with an example architecture such as that of FIG. 1; and

FIG. 10 illustrates a block diagram of an example computing apparatus that may be used as a component of an example architecture such as that of FIG. 1.

Any of the figures may be combined into a single example or embodiment.

### DETAILED DESCRIPTION

Aspects of the disclosure provide solutions for enhanced datastores for virtualized environments. A virtual datastore (e.g., a virtual volume datastore) is generated, along with a first virtual storage object (e.g., a virtual volume object) having a first storage policy. The first virtual storage object is configured into a first logical container datastore (e.g., a virtual machine (VM) file system datastore). The virtual datastore and the first logical container datastore are connected to a hypervisor in a tiered configuration, with the virtual datastore between the hypervisor and the first logical container datastore. Data is stored in the first logical container datastore according to the first storage policy. In some examples, the virtual datastore is a hybrid datastore having both a subordinate logical container datastore and a subordinate virtual storage object datastore. The logical container datastore is provisioned by the hypervisor and the virtual storage object is provisioned by the storage solution.

Aspects of the disclosure reduce the number of computing resources needed, thereby reducing power consumption, by improving the efficiency and flexibility of virtual datastores. This is accomplished in part by leveraging the various benefits of two types of virtual storage solutions: virtual storage objects and logical containers. Specifically, aspects of the disclosure configure a virtual storage object into a logical container datastore.

Some examples of virtual storage objects are implemented as virtual volumes, some of which are known as vVols, and some examples of logical containers are implemented as VM file systems, some of which are known as VMFSs. A vVol is a resizable, protocol agnostic, low-level storage for VMs that is independent of the underlying physical storage representation and supports operations on the storage array level, similar to traditional logical unit numbers (LUNs) that are used to create datastores. Some examples of vVol support VMFS over NVMe-FC, NVMe-TCP, iSCSI, SCSI-FC or NVME-RDMA.

A storage array defines how to provide access and organize data for VMs that are using the storage array. This enables array-based operations at the virtual disk level. Some examples of virtual storage objects provide a management and integration framework for a storage area network (SAN) and network-attached storage (NAS) that aligns storage consumption and operations with VMs, to render SAN/NAS devices VM-aware.

VMFS is a scalable cluster file system that is optimized for storing VM files, including virtual disks, in a VMFS datastore that uses folders. A VMFS datastore is a logical container that runs on top of a volume and uses the VMFS file system to store files on a block-based storage device or LUN. Examples of the disclosure allow for scaling VMFSs with vVOL storage objects for external storage. Some examples use a single vVol object per VMFS VM, with one storage policy per VMFS volume. This advantageously allows for volume resizing on demand and automatic storage placement, with less dependency on traditional storage administration.

In some examples, vSphere is in control of provisioning the vVol objects. vSphere is a virtualization platform that configures data center resources into aggregated computing infrastructures that include processing, storage, and networking resources. vSphere provides a hypervisor (e.g., ESXi) and a management function (e.g., vCenter) and uses vVols as an external storage solution. Using vVOL in vSphere for datastores provides support for multiple storage objects, and scales advantageously. With vVols, an individual VM and its disks, rather than a LUN, becomes a unit of storage management for a storage system, because vVols encapsulate virtual disks and other VM files.

Each of a virtual storage object and a logical container datastore has its own advantages. For example, a virtual storage object may have a storage policy, whereas a logical container datastore may be logically grown (e.g., non-destructively increased in size) by spanning multiple volumes together, or logically shrunk (e.g., non-destructively decreased in size) by deleting a volume, while the underlying VM is executing (e.g., running). A storage policy may control which type of storage is provided, which data services are offered, and map certain content to specific physical storage areas. Growing and shrinking a datastore, while a VM is executing, permits dynamic resizing. The combination permits dynamic resizing with storage policies.

Additionally, provisioning flexibility and migration speed of this hybrid approach are improved by advantageously leveraging the differing virtual storage arrangements disclosed herein. While provisioning of logical container datastores is owned by the hypervisor, which may also be referred to as a VM monitor (VMM), provisioning of virtual storage objects is owned by the storage solution. The storage solution may be, for example, a storage array that implements storage application program interfaces (APIs) for a virtualized environment, such as virtual storage APIs for storage awareness (VASA). Each type of virtual storage (e.g., virtual storage object and logical container) is thus provisioned in a more optimal manner.

Further, because virtual storage objects may be the subject of a snapshot, and may be cloned, malware resilience is improved. Upon detection of malicious logic (e.g., ransomware), a logical container datastore that is built on top of one or more virtual storage objects may now be restored using cloned snapshots, in the event that a malicious logic infection is detected, or a catastrophic hardware failure has occurred. Further malware resilience is provided by isolating each of multiple logical container datastores from each other (e.g., limiting the number of VMs that have access to each logical container datastore) that reside beneath a top-level virtual datastore in a tiered configuration.

The disclosed tiered configuration of a top-level virtual datastore, with multiple isolated logical container datastores beneath, reduces network traffic for storage protocol, for example, by reducing atomic test and set (ATS) commands for each transaction, even while the VMs in the various logical container datastores remain visible at a larger scale (e.g., to the entire cluster of VMs in a virtualization environment).

Examples are applicable to users who desire linearly-scaling storage performance for virtualization applications, users who need external storage service level agreement (SLA) and storage profile support, users who need deployment of a VM file system in cloud or cloud-like infrastructure, and others. With these and other advantages, aspects of the disclosure provide a practical, useful result to solve a technical problem in the domain of computing.

Examples of the disclosure provide a user-friendly solution that isolates the VMFS volume for each VM and backs it with a vVol storage object. These isolated volumes may be carved out dynamically over the vVol storage control path and placed under vVol datastore as “Micro VMFS datastores” or an isolated storage volume for a VM. Because these are relatively small, isolated volumes, file system metadata operations have far less contention than multiple hosts accessing a large VMFS volume. VMFS is able to leverage vVol storage object capabilities, such as storage policy-based deduplication, compression on a per-VM basis, and array assisted migration. In some examples, further extension permits use of array-based snapshot, replication, and cloning capabilities to further enhance VM workflows. Additionally, this reduces storage object consumption compared to traditional vVol usage. In some examples, a vVol needs one vVol object per virtual disk, one for swap, and one for the VM home folder, for a total of three. Using aspects of the disclosure, only a single vVol object is needed, in some examples.

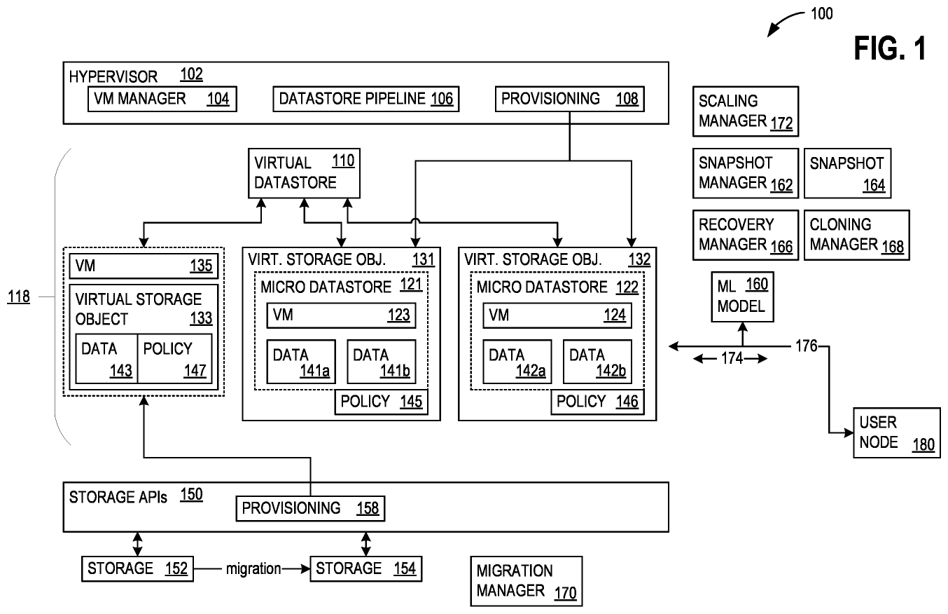

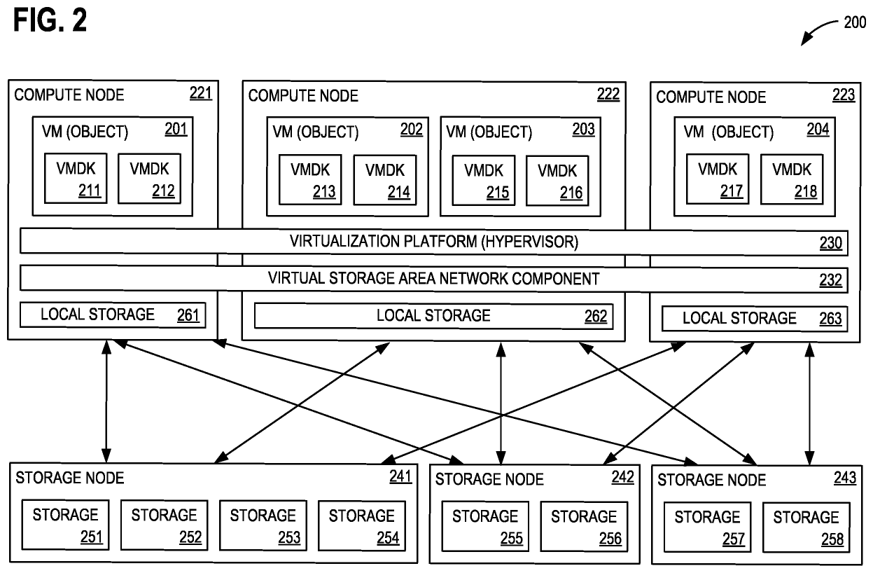

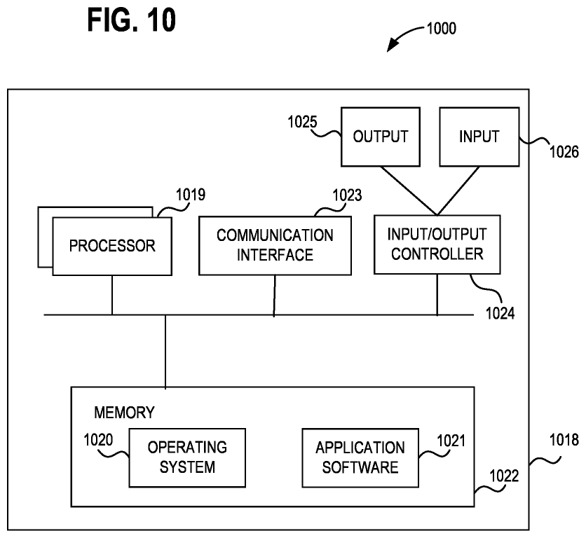

FIG. 1 illustrates an example architecture 100 that advantageously provides enhanced datastores for virtualized environments. Architecture 100 represents a virtualized environment, which may be implemented on one or more computing apparatus 1018 of FIG. 10 and/or using a virtualization architecture 200, as is illustrated in FIG. 2. In architecture 100, a hypervisor 102 manages multiple VMs, for example a VM 123, a VM 124, a VM 135, and possibly other VMs. A hypervisor is a layer of virtualization software that allows the creation and running of VMs, such as managing processor scheduling and physical memory allocation. A hypervisor may be a type-1, which has its own operating system (OS), or a type 2, which is a software application running under a host OS. In some examples, hypervisor 102 is a part of a vSphere deployment.

Hypervisor 102 has a VM manager 104 that creates and manages VMs 123, 124, and 135, and interfaces the underlying hardware to all OSs (both host and guest). Hypervisor 102 also has a datastore pipeline 106 that creates and manages a hybrid datastore configuration that is able to integrate multiple storage technologies (object or file), as described herein, and a provisioning manager 108 that provisions logical containers. Examples leverage the capability of vVol to provision and manage the storage object dynamically to create an isolated storage resource for VMFS volumes, called a “micro datastore” or “micro VMFS datastore” that dedicated to a VM. This architecture creates a hybrid datastore where at least two kinds of VMs can be located, either a native VMFS VM using a micro datastore (e.g., VMs 123 and 124) or a traditional vVOL-based VM (e.g., VM 135).

Architecture 100 also has a virtual datastore 110 that has subordinate datastores in a tiered configuration 118. In some examples, virtual datastore 110 comprises a virtual volume datastore, and which may include a SAN or NAS object. As illustrated, virtual datastore 110 comprises a hybrid data store having subordinate logical container datastores 121 and 122 and also a subordinate virtual storage object 133 that is employed as a virtual storage object datastore.

Each of logical container datastores 121 and 122 is identified in FIG. 1 as a micro datastore because the number of VMs that may write to each datastore is restricted, for example restricted to a relatively small number of VMs, such as one. This reduces resource contention, in comparison with a single large datastore that is accessed by a larger number of VMs (e.g., most or all of the VMs managed by hypervisor 102). Additionally, the access restriction to the relatively small number of VMs provides isolation that may be beneficial in the event that one of the datastores becomes infected with malware.

Logical container datastore 121 is implemented using VM 123, and is within a virtual storage object 131. Multiple data sets may be stored within logical container datastore 121, and two are shown: data 141a and data 141b. Data 141a and 141b are stored according to a storage policy 145 attached to logical container datastore 121. Logical container datastore 121 is able to benefit from a storage policy because logical container datastore 121 is within virtual storage object 131, which has storage policy 145.

Similarly, logical container datastore 122 is implemented using VM 124, and is within a virtual storage object 132. Multiple data sets may be stored within logical container datastore 121, and two are shown: data 142a and data 142b. Data 142a and 142b are stored according to a storage policy 146 attached to logical container datastore 122. Logical container datastore 122 is able to benefit from a storage policy because logical container datastore 122 is within virtual storage object 132, which has storage policy 146. Hypervisor 102 provisions logical container datastores 121 and 122 using provisioning manager 108.

In some examples, logical container datastores 121 and/or 122 use block storage and may comprise a VMFS datastore or a LUN. In some examples, logical container datastores 121 and/or 122 use file-based storage and may comprise a network file system (NFS). NFS is a mechanism for storing files on a network as a distributed file system that allows users to access files and directories located on remote computers and treat those files and directories as if they were local. In some examples, vSphere provisions logical container datastores 121 and 122.

An example scenario that uses an arrangement similar to that of architecture 100 is a pair of VMs, one of which processes structured query language (SQL) as a MySQL server, and requires high performance storage. The other VM operates merely as a logging server and is thus able to use less expensive storage. If the MySQL server uses logical container datastore 121, whereas the logging server uses logical container datastore 122, storage policy 145 will indicate higher performance requirements than will storage policy 146.

Virtual storage object 133 is employed as a virtual storage object datastore, which may be implemented as storage for a VM 135. In some examples, three are three virtual volumes (virtual storage objects) per VM. Data 143 is stored in virtual storage object 133, according to a storage policy 147 for virtual storage object 133. Virtual storage object 133 is provisioned by a provisioning manager 158 of storage APIs 150.

Storage APIs 150 enables recognize the capabilities of storage 152 152. In some examples, storage APIs 150 APIs is implemented as VASA. Different storage array vendors may provide their own custom storage APIs 150. The physical (hardware) storage solutions are provided by a storage 152 and a storage 154, either of which may comprise a storage array.

To fill out architecture 100, datastore pipeline 106 builds out tiered configuration 118 by generating virtual datastore 110, generating virtual storage objects 131 and 132, and then configuring virtual storage objects 131 and 132 into logical container datastores 121 and 122, respectively. In some examples, virtual storage objects 131 and 132 each comprises a SAN or NAS object for a VM, and/or a virtual volume. In some examples, each of logical container datastores 121 and/or 122 uses block storage and comprises VMFS or a LUN, or uses file-based storage and comprises an NFS. Each of logical container datastores 121 and 122 is managed as a virtual storage object, which allows on-demand based access to logical container datastores 121 and 122 on a limited number of hosts.

As shown in FIG. 1, a user node 180 transmits data to or retrieves data from logical container datastore 122 as input/output (I/O) traffic 174 over a data path 176. A machine learning (ML) model 160 intercepts I/O traffic 174 to monitor for indications of malicious activity, such as ransomware and improper data exfiltration (e.g., a data breach), as well as other data traffic to/from other datastores within architecture 100.

A snapshot manager 162 generates a snapshot 164 of virtual storage object 132 either on a scheduled basis and/or upon ML model 160 detecting a malicious logic trigger event (e.g., determining that I/O traffic 174 matches the profile of malicious activity). A recovery manager 166 is then able to restore logical container datastore 122 by using a cloning manager 168 to generate a clone of (at least) virtual storage object 132 from snapshot 164. The ability to clone the entirety of logical container datastore 122 is provided by cloning all of the virtual storage objects that make up logical container datastore 122.

FIG. 1 also shows an indication of a migration event, which is described in further detail in relation to FIG. 8. Migration of data 141a, 141b, 142a, and 142b and VMs 123, 124, and 135 in the various datastores is managed, at least in part, by a migration manager 170. By migrating data in the form of virtual storage objects, an entire virtual volume may be moved at once, providing a time saving over a file-by file, folder-by-folder, or object-by-object migration. A scaling manager 172 is able to provide dynamic resizing of logical container datastores 121 and 122 by adding or removing volumes while VMs 123 and 124 are executing. Further detail on dynamic scaling is provided in relation to FIG. 7.

In architecture 100, instead of provisioning a large VMFS volume from a logical unit number (LUN), or creating multiple large volumes using partitions, and sharing the same volume across multiple hosts, the hypervisor 102 provisions an adequate size VMFS volume per VM under a micro datastore for each VM. VMFS is used alongside vVol, in some examples, as backing storage for the VMFS volume. This approach provides a storage configuration that provides performance benefits due to isolation from other VMs and workflows. However, since it falls under a common datastore, it is still possible to easily migrate the VM, when needed.

VM-related provisioning operations, such as snapshot and clone, may be performed in the VMFS volume. As a VM virtual disk size increases or requires more storage, the storage object backing the VMFS volume may be resized (e.g., because vVols are resizable) to fulfill the storage requirement, or may be shrunk to reclaim storage space. Since the VMFS volume is effectively mounted to the specific host that executes the VM, it has less overhead during synchronization for file system metadata-related operations such as block allocation, deallocation, and unmap. Additionally, provisioning operations, such as snapshot and clone, may be handled natively in hypervisor 102. Such operation may optionally be offloaded to storage (e.g., storage APIs 150, or storage 152 or 154), where the storage handles the entire volume snapshot or clone.

During VM creation, in some examples, a corresponding vVol object of the required size is created and bound. Once bound, the vVol object is formatted with the VMFS file system, mounted as a micro datastore, and creates VM-related files in the newly created VM. For snapshot and clone operation, virtual disk related snapshot and clone may be handled natively in VMFS and the vVol object may resize if it runs out of storage, or if more storage is needed with disk addition or removal. A delete of the VM results in deletion of the corresponding vVol object.

Examples of architecture 100 provide crash consistency and rapid recovery of VMFS datastores by leveraging VMFS replication of vVOL objects. A vVol object has a storage policy (e.g., storage policy 145 or 146) and a quality of service (QoS) provided by the underling storage hardware. Thus, each volume created for VMFS may have an assigned VM policy that enforces QoS for the VMFS volume, meeting some heterogeneous storage requirements. If more than one performance policy is needed, multiple volumes may be created in which each holds a virtual disk with its own performance requirements. Other array features such as deduplication, compression and encryption are also part of storage policies, in some examples. This permits the range of vVol storage array-related capabilities to be applied to the encompassing VM.

Examples of architecture 100 are operable with virtualized and non-virtualized storage solutions. FIG. 2 illustrates a virtualization architecture 200 that may be used as a component of architecture 100. Virtualization architecture 200 is comprised of a set of compute nodes 221-223, interconnected with each other and a set of storage nodes 241-243 according to an embodiment. In other examples, a different number of compute nodes and storage nodes may be used. Each compute node hosts multiple objects, which may be virtual machines, containers, applications, or any compute entity (e.g., computing instance or virtualized computing instance) that consumes storage. A virtual machine includes, but is not limited to, a base object, linked clone, independent clone, and the like. A compute entity includes, but is not limited to, a computing instance, a virtualized computing instance, and the like.

When objects are created, they may be designated as global or local, and the designation is stored in an attribute. For example, compute node 221 hosts object 201, compute node 222 hosts objects 202 and 203, and compute node 223 hosts object 204. Some of objects 201-204 may be local objects. In some examples, a single compute node may host 50, 100, or a different number of objects. Each object uses a VMDK, for example VMDKs 211-218 for each of objects 201-204, respectively. Other implementations using different formats are also possible. A virtualization platform 230, which includes hypervisor functionality at one or more of compute nodes 221, 222, and 223, manages objects 201-204. In some examples, various components of virtualization architecture 200, for example compute nodes 221, 222, and 223, and storage nodes 241, 242, and 243 are implemented using one or more computing apparatus such as computing apparatus 1018 of FIG. 10.

Virtualization software that provides software-defined storage (SDS), by pooling storage nodes across a cluster, creates a distributed, shared datastore, for example a SAN. Thus, objects 201-204 may be virtual SAN (vSAN) objects. In some distributed arrangements, servers are distinguished as compute nodes (e.g., compute nodes 221, 222, and 223) and storage nodes (e.g., storage nodes 241, 242, and 243). Although a storage node may attach a large number of storage devices (e.g., flash, solid state drives (SSDs), non-volatile memory express (NVMe), Persistent Memory (PMEM), quad-level cell (QLC)) processing power may be limited beyond the ability to handle input/output (I/O) traffic. Storage nodes 241-243 each include multiple physical storage components, which may include flash, SSD, NVMe, PMEM, and QLC storage solutions. For example, storage node 241 has storage 251, 252, 252, and 254; storage node 242 has storage 255 and 256; and storage node 243 has storage 257 and 258. In some examples, a single storage node may include a different number of physical storage components.

In the described examples, storage nodes 241-243 are treated as a SAN with a single global object, enabling any of objects 201-204 to write to and read from any of storage 251-258 using a virtual SAN component 232. Virtual SAN component 232 executes in compute nodes 221-223. Using the disclosure, compute nodes 221-223 are able to operate with a wide range of storage options. In some examples, compute nodes 221-223 each include a manifestation of virtualization platform 230 and virtual SAN component 232. Virtualization platform 230 manages the generating, operations, and clean-up of objects 201-204. Virtual SAN component 232 permits objects 201-204 to write incoming data from object 201-204 to storage nodes 241, 242, and/or 243, in part, by virtualizing the physical storage components of the storage nodes.

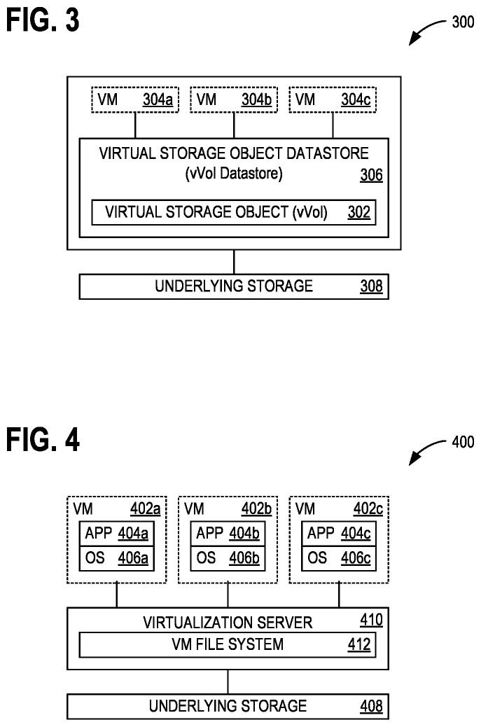

FIG. 3 illustrates an example of a virtual storage object arrangement 300, as may be used in the generation of virtual storage objects 131 and/or 132. A virtual storage object (which represents virtual storage object 131 or 132) is comprised of a set of VMs, such as a VM 304a, a VM 304b, and a VM 304c. Together, these form a virtual storage object data store 306 that holds a virtual storage object 302 and is physically stored on an underlying storage 308 (e.g., storage 152 or storage 154).

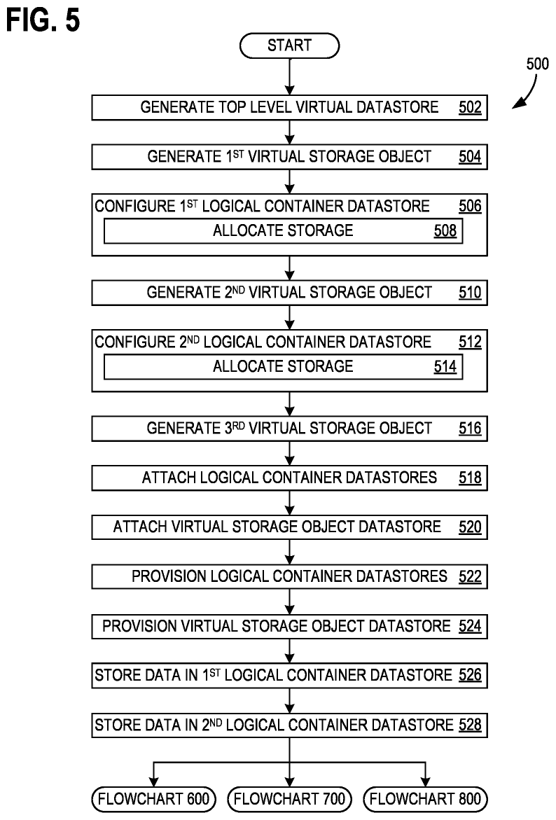

FIG. 4 illustrates an example of a VM file system arrangement 400, as may be used in the generation of logical container datastores 121 and/or 122. A set of VMs, such as a VM 402a, a VM 402b, and a VM 402c, each at least one application (app) and an OS. For example, VM 402a has an app 404a and an OS 406a; VM 402b has an app 404b and an OS 406b; and VM 402c has an app 404c and an OS 406c. These VMs 402a-402c run on a virtualization server 410 that stores and access VMs 402a-402c with a VM file system 412, similarly to the way a general computing device accesses and stores apps and other files using its native file system. An underlying storage 408 provides physical storage of the data and software.

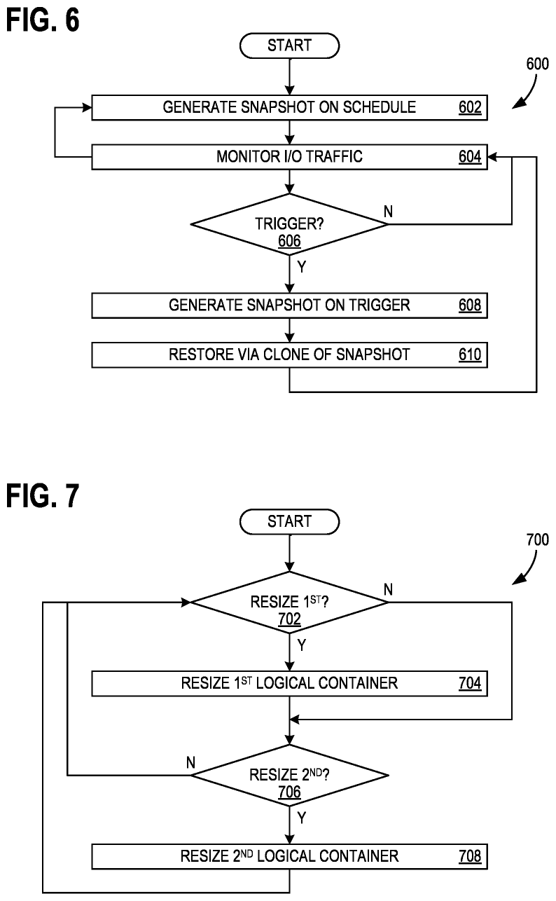

FIG. 5 illustrates a flowchart 500 of exemplary operations associated with providing enhanced datastores, as may be performed using examples of architecture 100. In some examples, the operations of flowchart 500 are performed by one or more computing apparatus 1018 of FIG. 10.

Flowchart 500 commences with datastore pipeline 106 generating virtual datastore 110 in operation 502. In operation 504, datastore pipeline 106 generates virtual storage object 131 having storage policy 145. Virtual storage object 131 has an I/O path that is based on its storage location (e.g., initially storage 152), although when virtual storage object 131 migrates (e.g., to storage 152, as is shown in FIG. 8), the I/O path for virtual storage object 131 may change. Datastore pipeline 106 configures virtual storage object 131 into logical container datastore 121 in operation 506, and allocates storage capacity for virtual storage object 131 in operation 508.

In operation 510, datastore pipeline 106 generates virtual storage object 132 having storage policy 146. Virtual storage object 132 has an I/O path that is based on its storage location (e.g., initially storage 152), although when virtual storage object 132 migrates (e.g., to storage 152, as is shown in FIG. 8), the I/O path for virtual storage object 132 may change. Datastore pipeline 106 configures virtual storage object 132 into logical container datastore 122 in operation 512, and allocates storage capacity for virtual storage object 132 in operation 514.

Datastore pipeline 106 generates virtual storage object 133 in operation 516, and attaches or connects the datastores in operations 518 and 520. In operation 518, datastore pipeline 106 attaches or connects virtual datastore 110 and logical container datastore 121 to hypervisor 102 in tiered configuration 118, with virtual datastore 110 in-between hypervisor 102 and logical container datastore 121, and also attaches logical container datastore 122 to hypervisor 102 in tiered configuration 118, with logical container datastore 122 also beneath virtual datastore 110. In some examples, only a single VM has write access to logical container datastore 121 and only a single VM has write access to logical container datastore 122. In some examples, each logical container datastore is accessed by a non-overlapping set of VMs that each operate beneath virtual datastore 110;

In operation 520, datastore pipeline 106 attaches virtual storage object 133 to hypervisor 102 in tiered configuration 118 as a virtual storage object datastore, with virtual storage object 133 beneath virtual datastore 110. Virtual datastore 110 comprises a hybrid data store having both a subordinate logical container datastore and a subordinate virtual storage object datastore.

Hypervisor 102 provisions logical container datastore 121 and logical container datastore 122 in operation 522. Storage APIs 150 (the computing entity other than hypervisor 102) provisions virtual storage object 133 in operation 524. In operation 526, VM 123 stores data 141, in logical container datastore 121 according to storage policy 145. In operation 528, VM 124 stores data 142, in logical container datastore 122 according to storage policy 146. Data 142, stored in logical container datastore 122, is isolated from data 141, which is stored in logical container datastore 121. Flowchart 500 then branches into flowcharts 600, 700, and 800 in parallel.

FIG. 6 illustrates a flowchart 600 of exemplary operations associated with providing malware protection for the enhanced datastores of architecture 100. In some examples, the operations of flowchart 600 are performed by one or more computing apparatus 1018 of FIG. 10. Flowchart 600 commences with snapshot manager 162 generating snapshot 164 of virtual storage object 131 on a schedule or some other regular trigger event. In operation 604, ML model 160 (or some other cybersecurity component) monitors I/O traffic 174 for logical container datastore 121.

Operations 602 and 604 remain ongoing until decision operation 606, in which ML model 160 detects a malicious logic trigger event during the monitoring of operation 604. In operation 608, ML model 160 instructs snapshot manager 162 to generate a final snapshot 164 of virtual storage object 131 in response to the malicious logic trigger event, unless the progression of the malicious logic attack has progressed too far.

In operation 610, recovery manager 166 restores logical container datastore 121 from snapshot 164 (which may have been generated in operation 602 or 608), based on at least detecting the malicious logic trigger event. Flowchart 600 then returns to operation 602.

FIG. 7 illustrates a flowchart 700 of exemplary operations associated with dynamically resizing (scaling during VM execution) of the enhanced datastores of architecture 100. In some examples, the operations of flowchart 700 are performed by one or more computing apparatus 1018 of FIG. 10.

Flowchart 700 commences with VM manager 104 or datastore pipeline 106 determining whether there is a need to resize logical container datastore 121, in decision operation 702. If not, flowchart 700 moves to decision operation 706. However, if there is a need to resize logical container datastore 121, datastore pipeline 106 resizes logical container datastore 121 in operation 704. This may even occur when VM 123 is still executing.

In decision operation 706, VM manager 104 or datastore pipeline 106 determines whether there is a need to resize logical container datastore 122. If not, flowchart 700 returns to decision operation 702. However, if there is a need to resize logical container datastore 122, datastore pipeline 106 resizes logical container datastore 122 in operation 708. This may even occur when VM 124 is still executing. Scaling manager 172 is able to provide dynamic resizing of logical container datastores 121 and 122 by adding or removing volumes while VMs 123 and 124 are executing.

FIG. 8 illustrates a flowchart 800 of exemplary operations associated with migrating the enhanced datastores of architecture 100. In some examples, the operations of flowchart 800 are performed by one or more computing apparatus 1018 of FIG. 10. Flowchart 800 commences with VM manager 104, datastore pipeline 106, or another component of architecture 100 determining whether there is a need to migrate logical container datastore 121 from storage 152 to storage 154, in decision operation 802.

In some examples the need for a migration may be determined based, at least in part, on the performance level, an SLA, and/or the If there is no need for a migration of logical container datastore 121, flowchart 800 moves to decision operation 806. However, if there is a need to migrate logical container datastore 121, migration manager 170 migrates logical container datastore 121 to a new storage location (e.g., from storage 152 to storage 154) in operation 804.

In decision operation 806, VM manager 104, datastore pipeline 106, or another component of architecture 100 determines whether there is a need to migrate logical container datastore 122 from storage 152 to storage 154. If not, flowchart 800 returns to decision operation 802. However, if there is a need to migrate logical container datastore 122, migration manager 170 migrates logical container datastore 122 to a new storage location (e.g., from storage 152 to storage 154) in operation 808. In some examples, the migration comprises moving an entire virtual storage object as a single moved object.

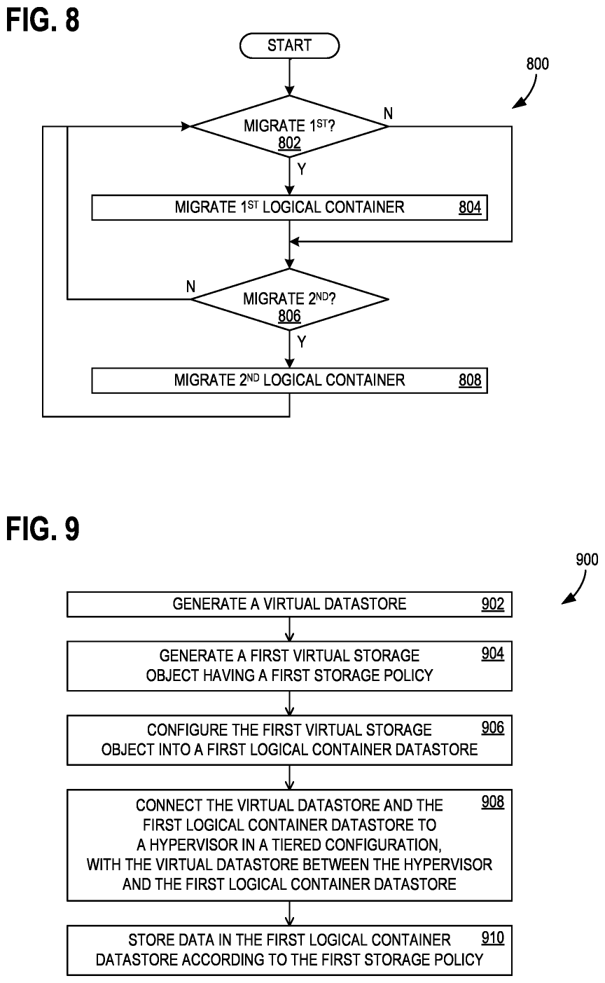

FIG. 9 illustrates a flowchart 900 of exemplary operations associated with architecture 100. In some examples, the operations of flowchart 900 are performed by one or more computing apparatus 1018 of FIG. 10. Flowchart 900 commences with operation 902, which includes generating a virtual datastore. Operation 904 includes generating a first virtual storage object having a first storage policy.

Operation 906 includes configuring the first virtual storage object into a first logical container datastore. Operation 908 includes connecting the virtual datastore and the first logical container datastore to a hypervisor in a tiered configuration, with the virtual datastore between the hypervisor and first logical container datastore. Operation 910 includes storing data in the first logical container datastore according to the first storage policy.

### Additional Examples

An example method comprises: generating a virtual datastore; generating a first virtual storage object having a first storage policy; configuring the first virtual storage object into a first logical container datastore; connecting the virtual datastore and the first logical container datastore to a hypervisor in a tiered configuration, with the virtual datastore between the hypervisor and first logical container datastore; and storing data in the first logical container datastore according to the first storage policy.

An example computer system comprises: a processor; and a non-transitory computer readable medium having stored thereon program code executable by the processor, the program code causing the processor to: generate a virtual datastore; generate a first virtual storage object having a first storage policy; configure the first virtual storage object into a first logical container datastore; connect the virtual datastore and the first logical container datastore to a hypervisor in a tiered configuration, with the virtual datastore between the hypervisor and first logical container datastore; and store data in the first logical container datastore according to the first storage policy.

An example non-transitory computer storage medium has stored thereon program code executable by a processor, the program code embodying a method comprising: generating a virtual datastore; generating a first virtual storage object having a first storage policy; configuring the first virtual storage object into a first logical container datastore; connecting the virtual datastore and the first logical container datastore to a hypervisor in a tiered configuration, with the virtual datastore between the hypervisor and first logical container datastore; and storing data in the first logical container datastore according to the first storage policy.

Alternatively, or in addition to the other examples described herein, examples include any combination of the following:
generating a second virtual storage object having a second storage policy different than the first storage policy;
configuring the second virtual storage object into a second logical container datastore;
attaching the second logical container datastore to the hypervisor in the tiered configuration, with the second logical container datastore beneath the virtual datastore;
storing data in the second logical container datastore according to the second storage policy, such that data stored in the second logical container datastore is isolated from data stored in the first logical container datastore;
a vSphere platform provisions the first logical container datastore and the second logical container datastore
only a single VM has write access to the first logical container datastore;
only a single VM has write access to the second logical container datastore;
generating a third virtual storage object;
attaching the third virtual storage object to the hypervisor in the tiered configuration as a virtual storage object datastore, with the third virtual storage object beneath the virtual datastore;
provisioning, by the hypervisor, the first logical container datastore;
provisioning, by a computing entity other than the hypervisor, the third virtual storage object;
resizing the first logical container datastore while its VM is executing;
migrating the first logical container datastore to a new storage location, wherein the migration comprises moving the first virtual storage object as a single moved object;
generating a snapshot of the first virtual storage object;
monitoring I/O traffic for the first logical container datastore;
detecting a malicious logic trigger event during the monitoring;
based on at least detecting the malicious logic trigger event, restoring the first logical container datastore from the snapshot;
the virtual datastore comprises a SAN or NAS object;
the virtual datastore comprises a virtual volume datastore;
the virtual datastore comprises a hybrid datastore having both a subordinate logical container datastore and a subordinate virtual storage object datastore;
the first virtual storage object comprises a SAN or NAS object for a VM;
the first virtual storage object comprises a virtual volume;
the first virtual storage object has a first I/O path;
the first logical container datastore uses block storage;
the first logical container datastore comprises a VMFS;
the first logical container datastore comprises a LUN;
the first logical container datastore uses file-based storage;
the first logical container datastore comprises a NFS;
configuring the first virtual storage object into the first logical container datastore comprises allocating storage capacity;
the hypervisor comprises a type-1 hypervisor;
each logical container datastore is accessed by a non-overlapping set of VMs that each operate beneath the virtual datastore;
each logical container datastore is accessed by a different LAN;
an ML model performs the monitoring of I/O traffic; and
resizing the second logical container datastore while its VM is executing.

### Exemplary Operating Environment

The present disclosure is operable with a computing device (computing apparatus) according to an embodiment shown as a functional block diagram 1000 in FIG. 10. In an embodiment, components of a computing apparatus 1018 may be implemented as part of an electronic device according to one or more embodiments described in this specification. The computing apparatus 1018 comprises one or more processors 1019 which may be microprocessors, controllers, or any other suitable type of processors for processing computer executable instructions to control the operation of the electronic device. Alternatively, or in addition, the processor 1019 is any technology capable of executing logic or instructions, such as a hardcoded machine. Platform software comprising an operating system 1020 or any other suitable platform software may be provided on the computing apparatus 1018 to enable application software 1021 to be executed on the device. According to an embodiment, the operations described herein may be accomplished by software, hardware, and/or firmware.

Computer executable instructions may be provided using any computer-readable medium (e.g., any non-transitory computer storage medium) or media that are accessible by the computing apparatus 1018. Computer-readable media may include, for example, computer storage media such as a memory 1022 and communications media. Computer storage media, such as a memory 1022, include volatile and non-volatile, removable, and non-removable media implemented in any method or technology for storage of information such as computer readable instructions, data structures, program modules or the like. Computer storage media include, but are not limited to, hard disks, RAM, ROM, EPROM, EEPROM, NVMe devices, persistent memory, phase change memory, flash memory or other memory technology, compact disc (CD, CD-ROM), digital versatile disks (DVD) or other optical storage, magnetic cassettes, magnetic tape, magnetic disk storage, shingled disk storage or other magnetic storage devices, or any other non-transmission medium (e., non-transitory) that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1022) is shown within the computing apparatus 1018, it will be appreciated by a person skilled in the art, that the storage may be distributed or located remotely and accessed via a network or other communication link (e.g. using a communication interface 1023). Computer storage media are tangible, non-transitory, and are mutually exclusive to communication media.

The computing apparatus 1018 may comprise an input/output controller 1024 configured to output information to one or more output devices 1025, for example a display or a speaker, which may be separate from or integral to the electronic device. The input/output controller 1024 may also be configured to receive and process an input from one or more input devices 1026, for example, a keyboard, a microphone, or a touchpad. In one embodiment, the output device 1025 may also act as the input device. An example of such a device may be a touch sensitive display. The input/output controller 1024 may also output data to devices other than the output device, e.g. a locally connected printing device. In some embodiments, a user may provide input to the input device(s) 1026 and/or receive output from the output device(s) 1025.

The functionality described herein can be performed, at least in part, by one or more hardware logic components. According to an embodiment, the computing apparatus 1018 is configured by the program code when executed by the processor 1019 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special purpose computing device when programmed to execute the instructions described herein. The detailed description provided above in connection with the appended drawings is intended as a description of a number of embodiments and is not intended to represent the only forms in which the embodiments may be constructed, implemented, or utilized. Although these embodiments may be described and illustrated herein as being implemented in devices such as a server, computing devices, or the like, this is only an exemplary implementation and not a limitation. As those skilled in the art will appreciate, the present embodiments are suitable for application in a variety of different types of computing devices, for example, PCs, servers, laptop computers, tablet computers, etc.

The term “computing device” and the like are used herein to refer to any device with processing capability such that it can execute instructions. Those skilled in the art will realize that such processing capabilities are incorporated into many different devices and therefore the terms “computer”, “server”, and “computing device” each may include PCs, servers, laptop computers, mobile telephones (including smart phones), tablet computers, and many other devices. Any range or device value given herein may be extended or altered without losing the effect sought, as will be apparent to the skilled person. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While no personally identifiable information is tracked by aspects of the disclosure, examples may have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” and “the” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computer-implemented method comprising:
generating a virtual datastore;
generating a first virtual storage object having a first storage policy;
configuring the first virtual storage object into a first logical container datastore;
connecting the virtual datastore and the first logical container datastore to a hypervisor in a tiered configuration, with the virtual datastore between the hypervisor and first logical container datastore; and
storing data in the first logical container datastore according to the first storage policy.

2. The computer-implemented method of claim 1, further comprising:
generating a second virtual storage object having a second storage policy different than the first storage policy;
configuring the second virtual storage object into a second logical container datastore;
connecting the second logical container datastore to the hypervisor in the tiered configuration, with the virtual datastore in-between the hypervisor and the second logical container datastore; and
storing data in the second logical container datastore according to the second storage policy, such that data stored in the second logical container datastore is isolated from data stored in the first logical container datastore.

3. The computer-implemented method of claim 2, wherein a vSphere platform provisions the first logical container datastore and the second logical container datastore.

4. The computer-implemented method of claim 2, wherein only a single VM has write access to the first logical container datastore and only a single VM has write access to the second logical container datastore.

5. The computer-implemented method of claim 1, further comprising:
generating a third virtual storage object;
connecting the third virtual storage object to the hypervisor in the tiered configuration as a virtual storage object datastore, with the third virtual storage object beneath the virtual datastore;
provisioning, by the hypervisor, the first logical container datastore; and
provisioning, by a computing entity other than the hypervisor, the third virtual storage object.

6. The computer-implemented method of claim 1, further comprising:
resizing the first logical container datastore while its VM is executing.

7. The computer-implemented method of claim 1, further comprising:
migrating the first logical container datastore to a new storage location, wherein the migration comprises moving the first virtual storage object as a single moved object.

8. The computer-implemented method of claim 1, further comprising:
generating a snapshot of the first virtual storage object.

9. The computer-implemented method of claim 8, further comprising:
monitoring input/output (I/O) traffic for the first logical container datastore;
detecting a malicious logic trigger event during the monitoring; and
based on at least detecting the malicious logic trigger event, restoring the first logical container datastore from the snapshot.

10. A computer system comprising:
a processor; and
a non-transitory computer readable medium having stored thereon program code executable by the processor, the program code causing the processor to:
generate a virtual datastore;
generate a first virtual storage object having a first storage policy;
configure the first virtual storage object into a first logical container datastore;
connect the virtual datastore and the first logical container datastore to a hypervisor in a tiered configuration, with the virtual datastore between the hypervisor and the first logical container datastore; and
store data in the first logical container datastore according to the first storage policy.

11. The computer system of claim 10, wherein the program code is further operative to:
generate a second virtual storage object having a second storage policy different than the first storage policy;
configure the second virtual storage object into a second logical container datastore;
connect the second logical container datastore to the hypervisor in the tiered configuration, with the virtual datastore in-between the hypervisor and the second logical container datastore; and
store data in the second logical container datastore according to the second storage policy, such that data stored in the second logical container datastore is isolated from data stored in the first logical container datastore.

12. The computer system of claim 11, wherein the program code is further operative to:
generate a third virtual storage object;
connect the third virtual storage object to the hypervisor in the tiered configuration as a virtual storage object datastore, with the third virtual storage object beneath the virtual datastore;
provision, by the hypervisor, the first logical container datastore; and
provision, by a computing entity other than the hypervisor, the third virtual storage object.

13. The computer system of claim 10, wherein the program code is further operative to:
resize the first logical container datastore while its VM is executing.

14. The computer system of claim 10, wherein the program code is further operative to:
migrate the first logical container datastore to a new storage location, wherein the migration comprises moving the first virtual storage object as a single moved object.

15. The computer system of claim 10, wherein the program code is further operative to:
generate a snapshot of the first virtual storage object;
monitor input/output (I/O) traffic for the first logical container datastore;
detect a malicious logic trigger event during the monitoring; and
based on at least detecting the malicious logic trigger event, restore the first logical container datastore from the snapshot.

16. A non-transitory computer storage medium having stored thereon program code executable by a processor, the program code embodying a method comprising:
generating a virtual datastore;
generating a first virtual storage object having a first storage policy;
configuring the first virtual storage object into a first logical container datastore;
connecting the virtual datastore and the first logical container datastore to a hypervisor in a tiered configuration, with the virtual datastore between the hypervisor and the first logical container datastore; and
storing data in the first logical container datastore according to the first storage policy.

17. The computer storage medium of claim 16, wherein the program code method further comprises:
generating a second virtual storage object having a second storage policy different than the first storage policy;
configuring the second virtual storage object into a second logical container datastore;
connecting the second logical container datastore to the hypervisor in the tiered configuration, with the second logical container datastore beneath the virtual datastore; and
storing data in the second logical container datastore according to the second storage policy, such that data stored in the second logical container datastore is isolated from data stored in the first logical container datastore,
wherein each logical container datastore is accessed by a non-overlapping set of VMs that each operate beneath the virtual datastore.

18. The computer storage medium of claim 17, wherein the program code method further comprises:
resizing the first logical container datastore while its VM is executing; and
resizing the second logical container datastore while its VM is executing.

19. The computer storage medium of claim 17, wherein the program code method further comprises:
generating a third virtual storage object;
connecting the third virtual storage object to the hypervisor in the tiered configuration as a virtual storage object datastore, with the third virtual storage object beneath the virtual datastore;
provisioning, by the hypervisor, the first logical container datastore; and
provisioning, by a computing entity other than the hypervisor, the third virtual storage object.

20. The computer storage medium of claim 16, wherein the program code method further comprises:
generating a snapshot of the first virtual storage object;
monitoring, by a machine learning (ML) model, input/output (I/O) traffic for the first logical container datastore;
detecting a malicious logic trigger event during the monitoring; and
based on at least detecting the malicious logic trigger event, restoring the first logical container datastore from the snapshot.
